(19) United States
(12) Patent Application Publication
(10) Pub. No.: US 2003/0147341 A1
(43) Pub. Date: Aug. 7, 2003

(54) Multilevel optical recording medium with transparent heat sink for laser read/write system

(76) Inventors: Alain Fargeix, Meylan (FR); Bernard Rolland, Meylan (FR); Veronique Gehanno, Grenoble (FR); Jean-Michel Bruneau, Teche (FR)

Correspondence Address: PEARNE & GORDON LLP, 526 SUPERIOR AVENUE EAST, SUITE 1200, CLEVELAND, OH, 44114-1484, US

(21) Appl. No.: 10/343,335

(22) PCT Filed: Aug. 20, 2001
(86) PCT No.: PCT/FR01/02634

(30) Foreign Application Priority Data
Aug. 21, 2000 (FR) 00/10762

(51) Int. Cl. G11B 3/70; G11B 5/84; G11B 7/26

(52) U.S. Cl. 369/284; 369/288

(57) ABSTRACT

The invention relates to a multi-level optical recording medium for a read/write system using a laser beam, comprising at least one substrate (4a, 4b) and a set of layers forming a deep level (12), and at least one semi-transparent level (10), each of these levels having two stable states reversible under the effect of laser radiation,

characterised in that the semi-transparent level comprises a layer (7) of phase change material and at least one heat absorption layer (21) placed in front of the layer of phase change material, such that the laser beam passes through the heat absorption layer before reaching the phase change material.

### FIELD OF THE INVENTION

The invention relates to an optical recording medium with a transparent heat sink with several levels that can be recorded and/or re-recorded using a laser read/write system.

The invention is used in applications in all fields of optical recording, for which the objective is to store a large quantity of data on an optical medium such as an optical disk. In particular, the invention is used for applications in the hifi and video fields for storage of digital sound and image data or in the domain of computer memories.

### STATE OF THE ART

FIG. 1 diagrammatically shows an optical type of a conventional information recording system. This recording system comprises an optical head reference 1 capable of emitting a laser beam 2.

This information recording system also comprises an information recording medium reference 3. Conventionally, this medium comprises a substrate 4 transparent to the light beam emitted by the optical head 1, and a set of superposed layers above the transparent substrate 4.

More precisely, the recording medium 3 comprises:

a first dielectric layer 6 located on top of the transparent substrate 4;

a memory layer 7 placed above the first dielectric layer 6;

a second dielectric layer 8 placed on the memory layer; and

a heat absorption and light reflection layer reference 9.

The memory layer 7, or the layer of phase change material, forms the information recording layer. This memory layer 7 may be made from a material such as Ge₂Sb₂Te₅ which has the special feature that it can be in a crystalline state or in an amorphous state. Information recorded in layer 7 is coded by a sequence of zones that are either in a first physical state (crystalline state) or in a second physical state (amorphous state). This coding in one or the other physical state is obtained by a variable degree of heating of the areas, so as to change the material from an amorphous state to a crystalline state or vice versa. More precisely, the metastable amorphous state is obtained by fusion, then by thermal quenching of the phase change material; the crystalline state is obtained by annealing the amorphous state. For example, fusion is obtained by increasing the temperature of the phase change material above its fusion temperature, in other words above about 600° C., by the use of a high laser power (typically 11 mW) and crystallization is obtained by increasing the temperature of this material to an intermediate temperature (of the order of 350° C.), using an average laser power level (typically 5 mW). The laser power can be modulated between the high level power and the medium level power with variable durations, and a write signal is generated that records the data sequence on the layer of phase change material by creating crystalline states and amorphous states with variable lengths aligned behind each other, along a pre-etched track (reference 5 in FIG. 1).

Reading may be done by the same laser source 1 kept at low power (of the order of 1 mW).

Small areas have to be made and illuminated by the laser beam for very short times, in order to obtain high storage capacities and high read/write speeds on optical disks. The size of the smallest possible domain for a DVD (Digital Versatile Disk) is about 0.5 μm, in other words of the order of magnitude of the diameter of the Airy spot (minimum diameter that can be obtained in far field, defined by the diffraction theory), to be suitably resolved while reading; the time for which a point on the disk is exposed to the laser spot is about 100 ns.

One critical characteristic of a phase change material is its crystallization rate that must be sufficiently high to erase the amorphous domain in less than 100 ns. On the other hand, a material with such a high crystallization rate requires fast thermal quenching when the laser beam is off. If not, the amorphous domain is badly resolved, or may not even exist. If it does not exist, the area melted at high power will be dynamically erased during cooling. Quenching rates compatible with the optical recording are of the order of 10° C./ns. They are obtained by setting a heat sink very close to the memory layer made of a phase change material. In general, this heat sink is a metal, which is also used as a reflector in order to increase the absorption efficiency of light in the memory layer.

The structure shown in FIG. 1 can achieve these results.

In this structure, the substrate 4 is transparent, which enables defocusing of dust, which is then no longer seen as a defect. The dielectric layer 6 can be used to adjust the optical properties of the disk such as reflectivity and acts as a thermal shield protecting the substrate 4; particularly when it is made of plastic.

The layer 7 of phase change material, also called the “memory layer”, records data in the form of a sequence of amorphous and crystalline areas.

The dielectric layer 8 acts as a control resistance for the heat flux that travels from the phase change layer 7 to the reflector and heat sink 9. This dielectric layer 8 controls the quenching rate for amorphization and is used to adjust the write and erase powers.

Finally, the layer 9 forming the reflector and the heat sink firstly reflects the light beam to increase the light absorption efficiency in the layer of phase change material 7, and secondly absorbs heat generated by the laser beam in the phase change layer 7, and that passed through the second dielectric layer 8.

At the present time, it is required to considerably increase the number of data to be memorized; therefore, it is necessary to increase the capacity of the optical disk. This can be done using a multi-level structure that enables recording of information on several memory layers, in other words on several layers of phase change material, each level comprising its own memory layer. This type of recording medium was described in patent application EP-A-0 810 590 and is shown in FIG. 2.

The recording medium described in this patent comprises a substrate 4a and a second substrate 4b separated by a first set of layers forming a first recording level 10 and a second set of layers forming a second recording level 12. The first level 10 is a semi-transparent level and the second level 12 is a deep level; they are separated from each other by a layer 11 of optically active glue. This layer of glue 11 firstly forms the bond between the semi-transparent level and the deep level, and secondly the optical decoupling of the two recording levels, so that information from one level does not interfere with reading of the other level. In order to achieve this, this glue layer must be thick (of the order of 50 μm for the DVD technology).

In this recording system, the optical head 1 focuses the laser beam 2 on one of the two levels 10 or 12. FIG. 2 shows the same laser beam when it is focussed on the transparent level 10 (in this case it is marked reference 2a) or on the deep level 12 (in this case it is marked reference 2b). When the laser beam 2 is focused on one of the levels, the field depth is such that the other layers in the structure are completely defocused and therefore their details are sufficiently averaged so that they do not disturb writing and/or reading the recording level concerned.

In this structure, the deep level 12 is identical to the medium shown in FIG. 1. The role of each of the four layers forming this level (first dielectric layer 22, memory layer 23, second dielectric layer 24 and reflector 25) is identical to the role of the layers 6, 7, 8 and 9 respectively, as described for FIG. 1. The substrate 4a performs the same role as substrate 4; the substrate 4b simply holds the assembly in place mechanically.

The semi-transparent level comprises a thermal resistance layer 20 and a heat absorption layer 21, placed between the memory layer 7 and the second dielectric layer 8.

The role of the thermal resistance layer 20 in this structure is to control the heat flux from the layer of phase change material 7 to the heat absorption layer 21. This layer 20 also controls the quenching rate for amorphization and the write and erase powers.

The heat sink layer 21 dissipates heat generated in the layer of phase change material and that has passed through the thermal resistance layer.

In this type of structure, each intermediate level must transmit sufficient light so that the deepest layer, in other words level 12, can be read and recorded. To achieve this, the layer 21 forming the heat sink must be made from a transparent material, or at the very least a very slightly absorbing material. For example, this material could be silicon carbide or some nitrides such as AlN and Si₃N₄, or some oxides such as ITO.

However, due to the intrinsic absorption characteristics of the layer 7 of phase change material, and therefore the resulting average transmission of light, in practice the structure is limited to two recording levels.

Furthermore, an efficient heat sink to achieve good overwriting causes deformations of the disk or micro-cracks that deteriorate electrical performances.

Document EP-A-0 810 590 also proposes to use materials in the memory layer with a polarity opposite to that defined in the standard, in other words the bottom of the layer is amorphous and writing generates crystalline areas. The amorphous bottom of the memory layer transmits light well, making it possible to write in sequence from the deepest levels working towards the shallower levels, with good transmission (therefore good power reserve) and considerable margin since partial crystallization does not deteriorate performances.

Once written, the various levels can be read by adjusting the gains of the signals and/or by modifying the laser read power. However, this structure cannot be used in a system with re-recording. In a multi-level re-recordable device, the level transmission drops by a factor of about 2 after writing and overwriting performances significantly deteriorate the margin on the erase (or recrystallization) power.

Furthermore in order to be efficient, the layer that forms the sink must be about twice as thick as the memory layer. Thus, in a structure with a single heat sink like that described above, this thickness is often high so that this heat sink layer can be bonded to the layers located below it. The material forming the heat sink has high intrinsic mechanical tension and compression stresses, such that the shear force that is proportional to the tension and compression stresses exceeds the ultimate stress. This type of structure causes stability problems. Micro-cracks can appear haphazardly around the surface of the disk, disturbing the electrical signals. These cracks may even cause complete separation of the structure.

Moreover, an erasable compact disk is described in the article entitled “The Feasibility of a CD-compatible Erasable Disc” by J. H. COOMBS et al., Technical Digest of 1994 Optical Data Storage Conference, TuC2-1, p. 59-60. This disk comprises a MIPIM (Metallic, Interferometric, Phase change, Interferometric, Metallic) structure in which one of the metallic layers is placed before the layer of phase change material to improve optical transmission of the laser beam. However, the necessary quenching is not possible with this structure since this metallic layer is located before the first dielectric layer and consequently is too far from the memory layer. Therefore, this metallic layer only performs an optical function in the structure.

Presentation of the Invention

The purpose of the invention is to overcome the disadvantages of the recording media described above. Consequently it proposes a multi-level re-recordable optical recording medium with good mechanical resistance. This medium keeps its flexibility on stacks of semi-transparent levels, in order to optimise the characteristics of each recording level in terms of reflectivity and contrast, transmission and thermal balance (in other words the ratio of light absorption between the crystalline state and the amorphous state of the phase change material).

More precisely, the invention proposes a multi-level optical recording medium for a read/write system using a laser beam, comprising at least one substrate and a set of layers forming a deep recording level, and at least one semi-transparent recording level, each of these levels having two stable states reversible under the effect of laser radiation. This medium is characterised by the fact that the semi-transparent recording level comprises a layer of phase change material and at least one heat absorption layer placed in front of the layer of phase change material, such that the laser beam passes through the heat absorption layer before reaching the phase change material.

According to one embodiment of the invention, the recording medium comprises a first and second layer of heat absorption material located on each side of the layer of phase change material. This embodiment has the advantage that it is mechanically stable.

Advantageously, the heat absorption layer is a material transparent to light with a high thermal conductivity.

For example, the heat absorption layer may be made of SiC, AlN, Si₃N₄ or ITO.

According to one embodiment of the invention, the heat absorption layer and the layer of phase change material are separated by a thermal resistance layer.

### BRIEF DESCRIPTION OF THE FIGURES

FIG. 1, already described, diagrammatically shows a recording medium with a conventional heat sink; FIG. 2, already described, diagrammatically shows a known recording medium with heat sink, with two levels; FIG. 3 diagrammatically shows a multi-level recording medium according to the invention; FIG. 4 shows a variant of the recording medium according to the invention; FIG. 5 shows jitter curves for the device according to the invention and for the device according to prior art.

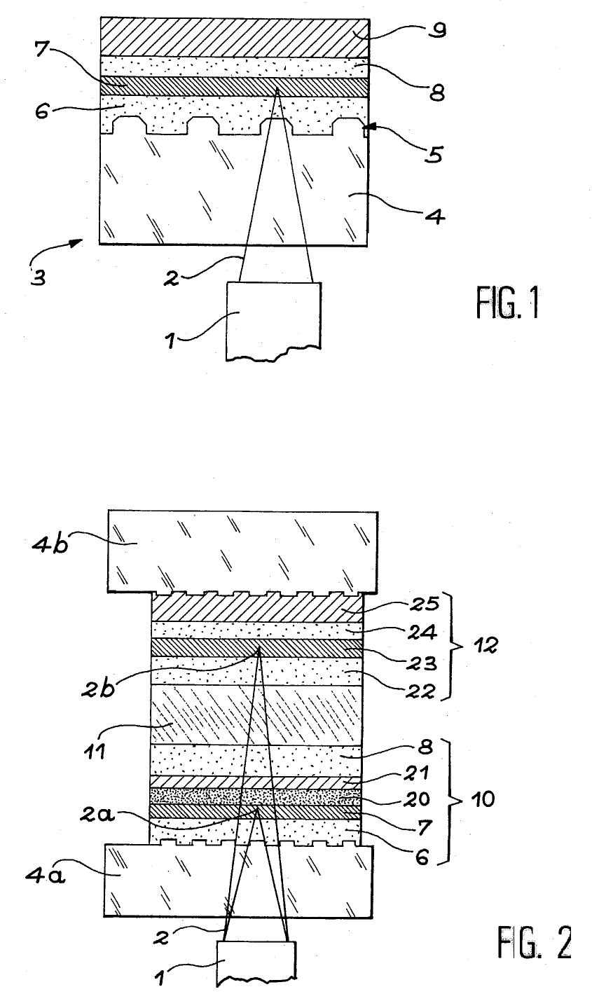

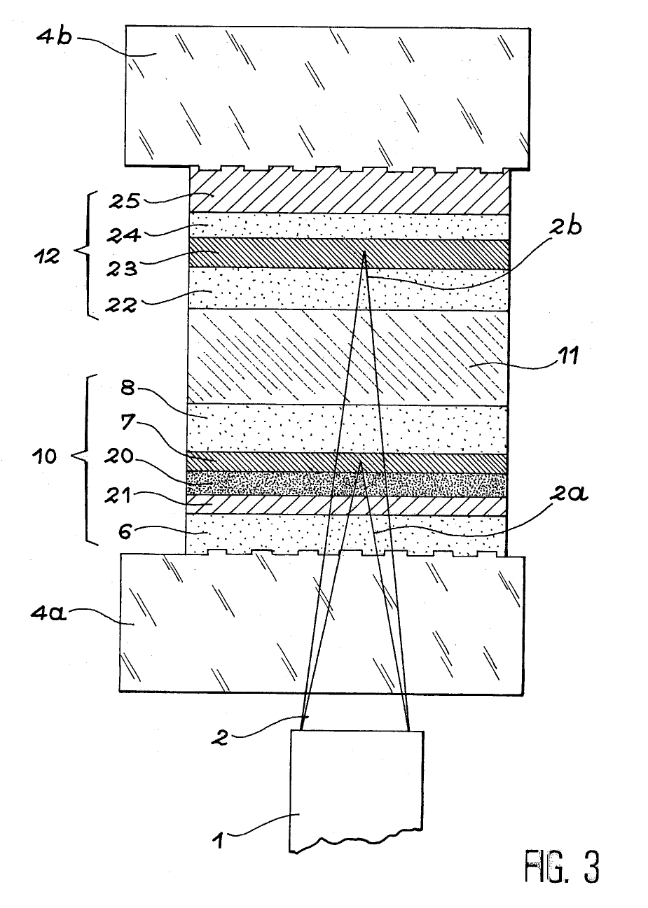

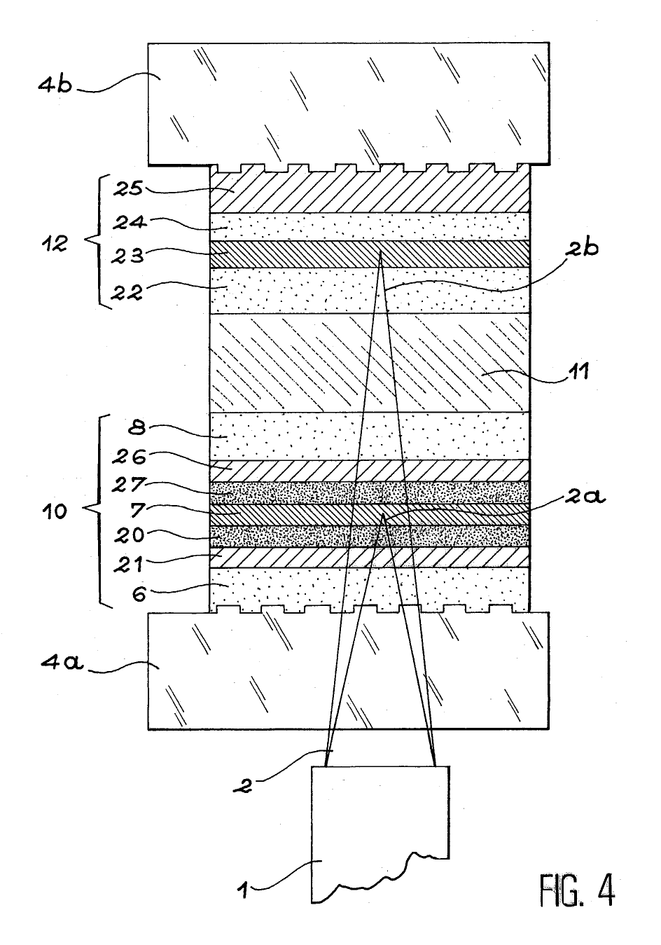

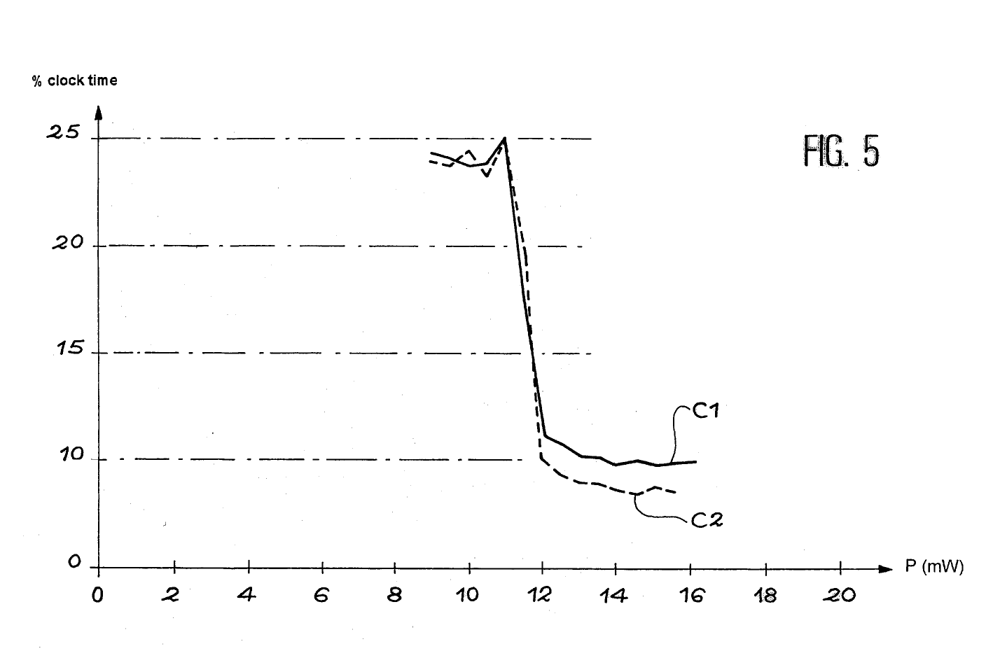

### DETAILED DESCRIPTION OF EMBODIMENTS OF THE INVENTION

The invention proposes an optical recording medium with heat sink with at least two recording levels that can be erased and re-recorded.

The recording medium according to the invention is shown diagrammatically in FIG. 3. In this figure, the layers of material that are identical to the layers of known structures, already described, have identical references.

The multi-level recording medium in FIG. 3 comprises a first substrate 4a with a defocusing role and a second substrate 4b with a holding role, between which a deep recording level 12 and a semi-transparent recording level 10 are placed, separated from each other by a thick layer of optically active glue reference 11.

However, note that the medium according to the invention may be made with a single substrate, the stiffness of the assembly being obtained by a judicious choice of materials forming the different recording levels.

In the embodiment shown in FIG. 3, the deep recording level 12 is strictly identical to the deep recording level of the structure shown in FIG. 2. Therefore, it will not be described in more detail. Similarly, the role of the optically active glue layer 11 is the same as for the recording medium in FIG. 2; therefore it will not be described again.

The invention lies in the level of the semi-transparent recording level 10, which comprises different layers of material specifically associated with each other to enable not only recording on the memory layer 23 of the deep level 12, but also erasing recordings made on the memory layers of the different recording levels, and then to re-write on these memory layers.

More precisely, the semi-transparent recording level 10 of the medium according to the invention comprises a first dielectric layer 6 placed above the first substrate 4a, and covered with a heat absorption layer 21 forming a heat sink, itself covered with a thermal resistance layer 20, and then a memory layer 7 and a second dielectric layer 8.

As already described, in known recording medium structures, the heat absorption layer 21 forming the heat sink is placed after the layer 7 of phase change material.

On the contrary, in the structure according to the invention, this heat absorption layer 21 is placed before the layer 7 of phase change material such that the laser beam passes through it before reaching the layer 7 of phase change material.

The quenching rate (between 10° C./ns and 150° C./ns) can be adjusted more easily with this structure.

In the structure according to the invention, the heat absorption layer 21 is made from a material that is transparent to light rays (so that the laser beam can be focused on the deeper recording levels), and also has a high thermal conductivity. For example, this heat absorption layer 21 may be made from SiC or AlN, or Si₃N₄ or ITO. These materials have the advantage that they are firstly transparent to light and therefore do not hinder incidence of the light beam, and secondly they are good heat conductors to absorb heat originating from the memory layer. A judicious choice of the indexes (stoichiometries and materials) and the thickness of the heat absorption layer help to optimise the adjustment of optical characteristics (such as reflectivity, contrast, heat balance and transmission) and electro-dynamic characteristics of the level considered; in particular, it makes it possible to obtain a jitter (in other words the standard deviation of the duration of read signals that exceed a predetermined threshold) lower than what can be obtained in structures according to prior art.

FIG. 5 shows the jitter variation curve (as a % of the clock time) with respect to the write power (in mW) for a recording medium with two levels according to the invention and for the recording medium according to prior art described above. In this figure, curve C1 shows the jitter for prior art; curve C2 shows the jitter for the structure according to the invention. It can be seen that the jitter in C2 is lower than the jitter in C1 and consequently that it is better.

For example, in order to make the semi-transparent level of a re-writable optical disk, we could choose ZnS/SiO₂ in the proportion 70%/30% for the dielectric of both layers 6 and 8, with thicknesses of 120 nm for layer 6 and 110 nm for layer 8. For this example, we could choose a 10 nm thick SiC heat sink, and a 10 nm thick thermal resistance layer 20 made of the same material as the dielectric layers. The memory layer 7, in other words the layer of phase change material, may be 7 nm thick and made of GeSbTe 2/2/5.

For example, it would also be possible to propose a deep level 12 in which the two dielectric layers 22 and 24 are made of the same material as the dielectric layers in the semi-transparent recording level, but with thicknesses of 100 nm and 40 nm respectively. In this deep level 12, the layer 23 of phase change material may be 17 nm thick and made from the same material as the layer of phase change material in the semi-transparent recording level. Finally, the layer 25 forming the reflector and the heat sink may be 80 nm thick and made from Al.

In this example, the transmission of the semi-transparent recording level is about 55% when the phase change material is amorphous and about 35% when it is crystalline. The average transmission of the semi-transparent recording level is then about 45% when it is fully written.

In this type of structure, crystalline reflectivities are about 18% for the semi-transparent level and 8% for the deep level. The contrast of the semi-transparent level is low (about 20%) whereas the contrast of the deep level is high (about 50%). The thermal balances (in other words the absorption ratios of light in the memory layer between the crystalline state and the amorphous state) are 1.3 for the semi-transparent level and 0.9 for the deep level. In this example, the optimum write powers for the optical head are normal for the semi-transparent level (in other words about 12 mW) and high for the deep level (in other words about 18 mW).

FIG. 4 diagrammatically shows a variant of the recoding medium according to the invention. In this variant, the layer of phase change material 7 is surrounded by two heat absorption layers 21 and 26, each of these heat absorption layers being associated with a heat resistance layer, 20 and 27 respectively. These two layers 21 and 26 may be the same order of thickness as the memory layer 7.

The advantage of such a structure with two heat sinks sandwiching the memory layer is that it facilitates quenching of the material forming this memory layer. If there is no heat sink, the heat generated in the layer of phase change material would diffuse equally towards the entry medium and towards the exit medium. The heat sinks on each side of the layer of phase change material capture the heat and very significantly accelerate this diffusion.

This structure with two heat sinks also has the advantage that it is mechanically more stable and therefore its quality is better.

In the second embodiment according to the invention, the different layers could for example be chosen as follows: the dielectric layers 6 and 8, and the thermal resistance layers 20 and 27 may be made of Zns/SiO₂ in the proportion 70%/30%; their thicknesses may be 120 nm for layer 6, 110 nm for layer 8, 10 nm for layer 20 and 10 nm for layer 27. The heat absorption layers forming the heat sinks 21 and 26 may each be 5 nm thick and may be made of SiC. Finally, the layer 7 of phase change material may be 7 nm thick and made of GeSbTe, in the proportion 2/2/5.

The deep level may be chosen to be identical to the deep level given in the example in the first embodiment. As in the first embodiment, we then obtain an average transmission of the transparent level of the order of about 45% and characteristics approximately identical to the characteristics given for the example of the first embodiment.

The fact of placing a heat absorption layer before the memory layer in the direction of propagation of the laser beam (case in FIG. 3) or placing an absorption layer before and an absorption layer after the memory layer (case in FIG. 4) makes it possible to have better control over problems related to mechanical stresses that induce cracking in layers or which cause deformations of the optical disk. The radial or axial film of the disk, when it is finished, is an important specification given in each optical disk standard. These characteristics are even more critical and difficult to maintain if the structure is deformable, for example if it is made of plastic, and if bond is optically active (for example in the case of multi-level DVDs).

The invention has just been described for two recording level structures, but obviously it could be used for structures with n levels; in this case, there is one deep layer and n−1 semi-transparent levels. It is possible to make several levels since the average transmission ratio of a semi-transparent level enables good focussing on layers of phase change material at each intermediate semi-transparent level through which the laser beam will pass before reaching the deep level.

The recording medium according to the invention may be made as follows, regardless of the particular embodiment:

for each semi-transparent level:

make a matrix following the conventional direction; the conventional direction is imposed by the standard for a single level disk. In the case of the DVD + RW single level rewritable disk standard, the spiral described by the tracks follows the anticlockwise direction of rotation when looking from the laser entry side. This direction is opposite to the direction applied to the lithography machine that insolates the tracks;

make the substrate; the substrate is obtained by injection of hot polycarbonate (or PMMA) into a mould at high pressure;

deposit the stack of the memory layer and heat sink; this gives five layers for the embodiment in FIG. 3 or seven layers for the embodiment in FIG. 4;

initialise; in the example, initialisation, in other words crystallisation of the entire surface of the disk, is done before gluing; however, it could be done after gluing;

in the case of several semi-transparent levels:

deposit a spacer (about 50 μm thick);

etch tracks on the free surface of the spacer;

deposit the stack and then initialise each level iteratively, starting from the deposition of the spacer;

for the deep recording level:

make a matrix in the inverse direction; if the previously described conventional direction is kept, the spiral described by the tracks will be in the clockwise direction of rotation when looking from the entry side of the laser once the disk is finished. Since it is impossible to change the direction of rotation of the motor, an inverse spiral will have to be recorded on the disk;

make the substrate; the substrate is obtained by injection of hot polycarbonate into a mould at high-pressure;

deposit the stack of memory layers; namely four layers;

initialise; in our example, initialisation, in other words crystallization of the entire surface of the disk, is done before gluing;

gluing; the two parts (the deep level and all semi-transparent levels) need to be glued and kept separate at a distance of about 50 μm. Since the laser beam passes through the glue, it must have an excellent optical quality. Furthermore, the axes of rotation of the two disks must be perfectly coincident, in order to prevent eccentricities;

test; an on-line test is carried out first in which fast global measurements are made, usually by optical measurements (such as diffraction fault, etc.), followed by a more detailed test on off-line dynamic testers.

1. Multi-level optical recording medium for a read/write system using a laser beam, comprising at least one substrate (4a, 4b) and a set of layers forming a deep level (12), and at least one semi-transparent level (10), each of these levels having two stable states reversible under the effect of laser radiation,
characterised in that the semi-transparent level comprises a layer (7) of phase change material and at least one heat absorption layer (21) placed in front of the layer of phase change material, such that the laser beam passes through the heat absorption layer before reaching the phase change material.

2. Recording medium according to claim 1, characterised in that it comprises a first and second layer (21, 26) of heat absorption material located on each side of the layer of phase change material.

3. Recording medium according to claim 1 or 2, characterised in that the heat absorption layer is a material transparent to light with a high thermal conductivity.

4. Recording medium according to claim 3, characterised in that the heat absorption layer is made of SiC, AlN, Si₃N₄ or ITO.

5. Recording medium according to any one of claims 1 to 4, characterised in that the heat absorption layer and the layer of phase change material are separated by a thermal resistance layer (20, 27).
